(19) United States
(12) Patent Application Publication
(10) Pub. No.: US 2009/0024948 A1
(43) Pub. Date: Jan. 22, 2009

(54) Method and apparatus for conducting a support and diagnostic session on a remote computer

(76) Inventor: Marton B. Anka, Budapest (HU)

Correspondence Address: LAW OFFICE OF DAVID H. JUDSON, 15950 DALLAS PARKWAY, SUITE 225, DALLAS, TX, 75248, US

(21) Appl. No.: 11/781,261

(22) Filed: Jul. 22, 2007

(51) Int. Cl. G06F 15/16; H04L 9/28; G06F 3/048

(52) U.S. Cl. 715/771; 713/153

(57) ABSTRACT

In a remote support and diagnostic system, the supported computer is automatically identified via a computer identifier that is stored with the support history in the gateway servers. The computer identifier is generated from several pieces of information concerning the hardware and the operating system of the host computer which are collected during a support session. This information is combined and applied to a one-way cryptographic hash function to produce a computer identifier. The identifier is then stored with, and used to retrieve, the support history. This identifier has a very high likelihood to be unique to a particular computer system, yet it does not expose any potentially sensitive data that is used to make up the identifier.

### BACKGROUND

In many situations, businesses and users have computer systems to which they must have constant access. Computer problems can cause serious disruptions. These problems often take the form of software bugs, system crashes, new software installation problems, network connection problems, computer viruses and other “malware” problems. The loss of computer services quickly translates into wasted time, missed schedules and lost revenue.

Conventionally, the mechanism for individuals and small businesses to deal with such problems involved providing telephone-assisted support in which a technician, located off-site, discussed the problem with the user and suggested various actions intended to elicit the problem and then repair the computer. However, such methods assumed that the user was sophisticated enough to follow the directions given by the technician and that the user had sufficient administrative rights on the supported computer to perform the actions. If the telephone-assisted support failed to correct the problem, the only alternative was to bring the computer to a repair depot. This allowed sophisticated technicians to work on the problem, but resulted in substantial downtime transporting the system to the repair depot and waiting for the technician to begin work on the system. Larger businesses employed contract technicians who traveled to the equipment location and repaired the equipment “on-site.” While this latter method substantially reduced downtime, it was expensive and time-consuming because time for the technician to travel to the equipment site was involved.

If the computer was connected to a network, it was also possible to diagnose problems and provide support over the network. Support could also be provided over direct dial telephone lines. However, this type of operation generally required the user to obtain and install a substantial diagnostic program in the computer to be supported in order to provide reasonable diagnostic capabilities. Many users do not have the sophistication to correctly install such a diagnostic program nor do they understand how to set up a connection between the diagnostic program and the technical support center.

Conventional remote access systems allow a technician to connect a support computer to another remote computer over a network (generally the Internet) so that the technician can use this support computer to diagnose and repair the remote computer. Once connected to the remote computer, the technician can enter keyboard and mouse commands into the remote computer and the commands will be transmitted to, and processed by, the remote computer just as if the user had entered the commands into the remote computer. Similarly, screen displays generated at the remote computer are transmitted to, and reproduced by, the technician computer.

In traditional remote access solutions there are two components: the “host computer” (the computer being accessed) and the “client computer” (the computer used to access the host). The host software accepts a connection over a network, such as the Internet, from the client software, and after an initial authentication phase, a remote access session begins. In order to operate properly, a remote access system must be able to efficiently transfer information between the client and host computers and this efficient transfer requires a stable connection. If the client and host computers are directly connected to the network with static network addresses, establishing this stable connection is relatively easy. However, firewalls and NAT (Network Address Translation) routers that change or mask network addresses are becoming increasingly common, and dynamic network addresses are typically assigned to home users who access the Internet. Therefore, setting up a traditional remote access system in which the client computer directly contacts the host computer is not always practical as the difficulty of the task often exceeds the technical capabilities of the user.

In order to solve this problem, typical remote access systems introduce a third component, called a “gateway” that is connected to the network. The gateway is usually a combination of hardware and software that receives incoming connections over the network from both the client computer and the host computer. The gateway is often a server that is connected to the Internet and is typically located in a datacenter that is off-site for both the host computer and the client computer.

In a gateway-based remote access system, the host computer usually initiates a connection to the gateway, for example, when it boots up and thereafter maintains a constant connection with the gateway. The client computer usually connects to the gateway only when a user action initiates such a connection to begin a remote access session. In some remote access systems, when the requested host instance is identified, then the gateway will forward data between the respective client and host instances. In other “peer-to-peer” remote access systems, a remote access session is established with the assistance of a gateway, but after the session is established, data passes directly between the client computer and the host computer.

Because both types of remote access systems generally allow the remote computer to control many functions of the host computer, an opportunity is provided to allow remotely located support personnel to offer support in the form of remote diagnostic and repair services on the host computer. When starting a problem resolution session, a user at a computer in need of support downloads a small program from a diagnostic website. This program then connects the host to the gateway computer and makes selected information of the host computer visible on a remotely-located “technician console” computer used by the personnel providing support. In many cases, the problem can then be resolved using standard tools, such as remote control and file transfer.

During the problem resolution session, a detailed log of the communication between the host computer and the technician console computer is often generated and may be displayed both for a user at the host computer and the technician. Because this information is typically very useful should further support be necessary, it is commonly stored on servers at the gateway as a support history for the supported computer for later retrieval by another technician.

When the same computer system requires support in the future, the support history of the particular system can be retrieved for the reference of the technician resolving the incident. However, retrieving the support history for a particular computer system that is supported repeatedly generally requires the user to remember and provide one or more case numbers associated with the previous support sessions to the supporting technician.

### SUMMARY

In accordance with the principles of the invention, the supported computer is automatically identified via a computer identifier that is stored with the support history in the gateway servers. The computer identifier is generated from several pieces of information concerning the hardware and the operating system of the host computer which are collected during a support session. This information is combined and applied to a one-way cryptographic hash function to produce a computer identifier. The identifier is then stored with, and used to retrieve, the support history. This identifier has a very high likelihood to be unique to a particular computer system, yet it does not expose any potentially sensitive data that is used to make up the identifier.

In accordance with one embodiment, examples of collected data include the MAC address of the primary network adapter, the CPU type and speed, the serial number of the system hard drive and the operating system product ID. While any one piece of the above information alone would probably not be enough to uniquely identify a computer, and the risk of a false positive would be high, when, for example, a hard drive is moved from one computer to another, the combination of the various pieces can produce a unique identifier.

In accordance with another embodiment, the program which is downloaded from the diagnostic website to the host computer to begin the support session collects the information from the host computer in order to generate the computer identifier.

### BRIEF DESCRIPTION OF THE DRAWINGS

FIG. 1 is a block schematic diagram of a remote control system which performs diagnostic and support operations on a supported computer in accordance with the principles of the invention.

FIG. 2 is a flowchart illustrating the steps in establishing a diagnostic and support session between a technician computer and a supported computer using the remote access system of FIG. 1.

FIG. 3 is a screen shot of an illustrative screen display that would be viewed by a user at a supported computer during a diagnostic and support session in accordance with the inventive principles.

FIG. 4 is a screen shot of an illustrative screen display that would be viewed by a technician at a technician computer during a diagnostic and support session in accordance with the inventive principles.

FIG. 5 is a block schematic diagram of an apparatus that can be used to compute an identifier for the supported computer in order to retrieve history information and notes that were generated during a previous support session and saved.

FIG. 6 is a flowchart illustrating the steps in computing a computer identifier for the supported computer using the apparatus of FIG. 5.

FIG. 7 is a screen shot of an illustrative screen display that would be used to display saved support history for viewing by a technician during a later support session.

FIG. 8 is a screen shot of an illustrative screen display that would be used to display saved support notes for viewing by a technician during a later support session.

### DETAILED DESCRIPTION

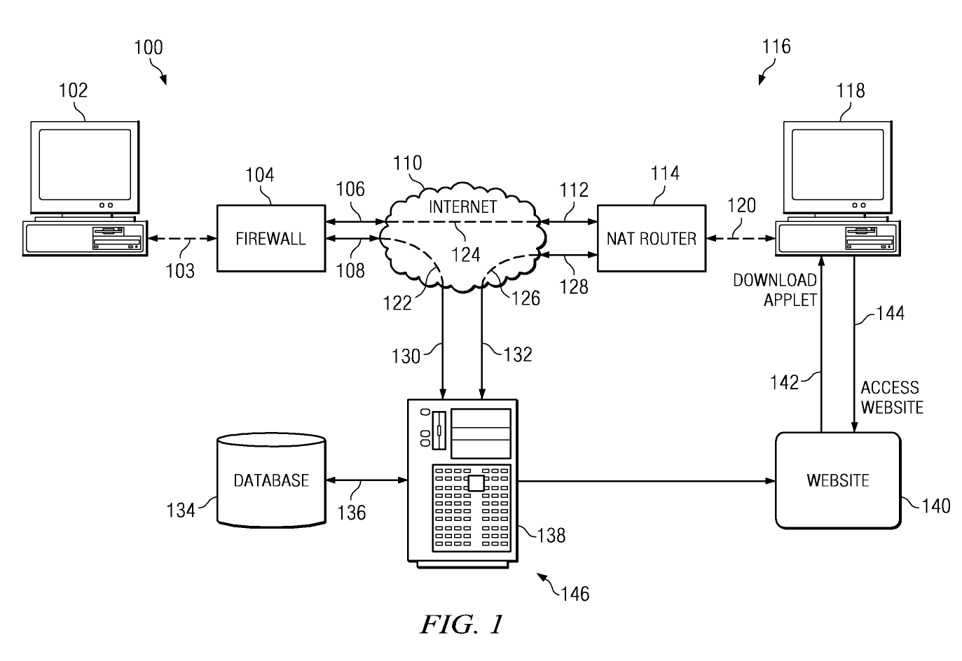

FIG. 1 shows a conventional network setup using firewalls and NAT routers. For example, a network 100 is connected by a firewall 104 to the Internet 110 and a network 116 is connected to the Internet 110, via a NAT router 114. The network 100 typically includes a plurality of computers, of which only computer 102 is shown for clarity. The computers may be connected by a LAN network (not shown) to one or more servers (also not shown). The LAN network is, in turn, connected to the Internet 110 by means of a firewall 104. The firewall 104 commonly has connections to the Internet 110 that are schematically illustrated as arrows 106 and 108. The firewall 104 is generally a program or hardware device that filters the information coming from the Internet connections 106 and 108 into the network 100. If an incoming packet of information is flagged by the filters, it is not allowed through the firewall 104.

In a similar manner, network 116 is connected by a NAT router 114 to the Internet 110. The network 114 also typically includes a plurality of computers of which only computer 118 is shown for clarity. The NAT router 114 has connections to the Internet 110 that are schematically illustrated as arrows 112 and 128.

The NAT router 114 provides address translation that allows the network 116 to use private network addresses (called unregistered or non-routable addresses) without interfering with normal Internet addresses (called registered or routable addresses). The NAT router 114 maps an unregistered network address to a registered network address that is selected from a group of registered network addresses assigned to the router. This mapping may be either fixed or dynamic, in which the mapping is maintained only during a connection between an unregistered and a registered address. Conventional remote access programs have mechanisms for dealing with the complications introduced by firewalls and NAT routers.

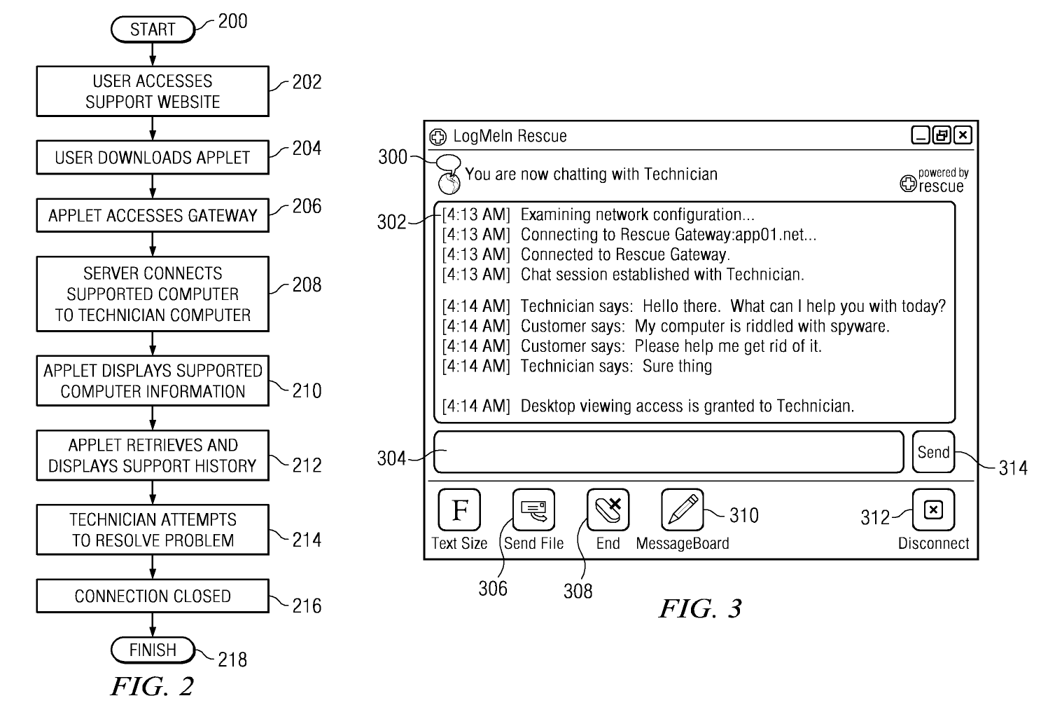

With such a remote access system, a support and diagnostic session can be conducted on a supported computer, for example, computer 118 via a technician computer, for example, computer 102. The process for establishing this connection is illustrated by the flowchart in FIG. 2. The process starts in step 200 and proceeds to step 202 where the support session is initiated when the supported computer 118 accesses a website, schematically illustrated as website 140. This website may be hosted by a server 138 at a gateway location 146 or at a server located elsewhere. This access is schematically represented by arrow 144. In step 204, by selecting an icon or by another conventional manner, a user at the supported computer 118 causes an “applet” or a small executable program to be downloaded from the website server (in this case server 138) to the supported computer 118 as indicated schematically by arrow 142.

In step 206, the applet causes the supported computer 118 to access the gateway server 138, via the NAT router 114, as indicated schematically by arrows 120, 128, 126 and 132. When this access occurs, in step 208, the server 138 connects the supported computer to the technician computer 102 via the firewall 104 as indicated schematically by arrows 130, 122, 108 and 103. For example, the server 138 may place a reference to the supported computer in a queue. When a technician reaches the supported computer in the queue, a connection is established between the technician computer 102 and the supported computer 118. In this manner, a temporary remote access session is established between the technician computer 102 and the supported computer 118. For security purposes, the information passing between the technician computer and the supported computer may be encrypted. In peer-to-peer remote access systems, after the initial connection has been establishes an additional pathway indicated by arrows 106, 124 and 112 may be set up so that data and commands can be directly transferred between the technician computer and the supported computer without passing through the gateway 146.

Once this remote access session is established, in step 210, the applet running in the supported computer 118 makes selected information of the supported computer 118 visible on the display screen of the technician computer 102. This information can include running services and processes, installed applications and recent system events.

In accordance with the principles of the invention, and as discussed below, in step 212, the applet can also automatically retrieve and display support history information and technician-entered notes from previous support sessions for the supported computer.

In step 214, a technician at the technician computer 102 can then try to resolve the problem using standard tools, such as on-line chat service, desktop viewing, remote control and file transfer for installing software patches and upgrades. The technician may also be able to reboot the supported computer and reconnect to it via the network. For security purposes, the user at the supported computer may have to explicitly grant permission to the support personnel for remote viewing of the supported computer display screen, for remote control, file transfer and viewing of system information. At the end of the support session, either the technician or the user closes the connection as set forth in step 216 and the process finishes in step 218.

During the problem resolution session, a detailed log of the communication between the host computer and the technician console computer is often generated and may be displayed both for a user at the host computer and the technician. FIG. 3 is an illustrative screen shot of the screen display presented to a user at the supported computer during a support session, for example, by means of a pop-up window. The display comprises a window 300 which contains a scrolling list 302 of both events that take place during the support session and chat questions and responses between the user and the technician. The display 300 also includes a textbox 304 into which the user can enter a chat question. The chat question can then be sent to the technician by selecting “send” button 314.

The display 300 also includes additional command buttons that can be used to perform several different tasks. A “Send File” button 306 can be selected to initiate a file transfer from the supported computer 118 to the technician computer. An “End” button 308 can be used to terminate any remote control sessions initiated by the technician. When selected, “Whiteboard” button 310 opens a shared “whiteboard” which is a window in which both the user and the technician can enter information. Finally, a “disconnect” button 312 can be selected by the user to immediately end a support session.

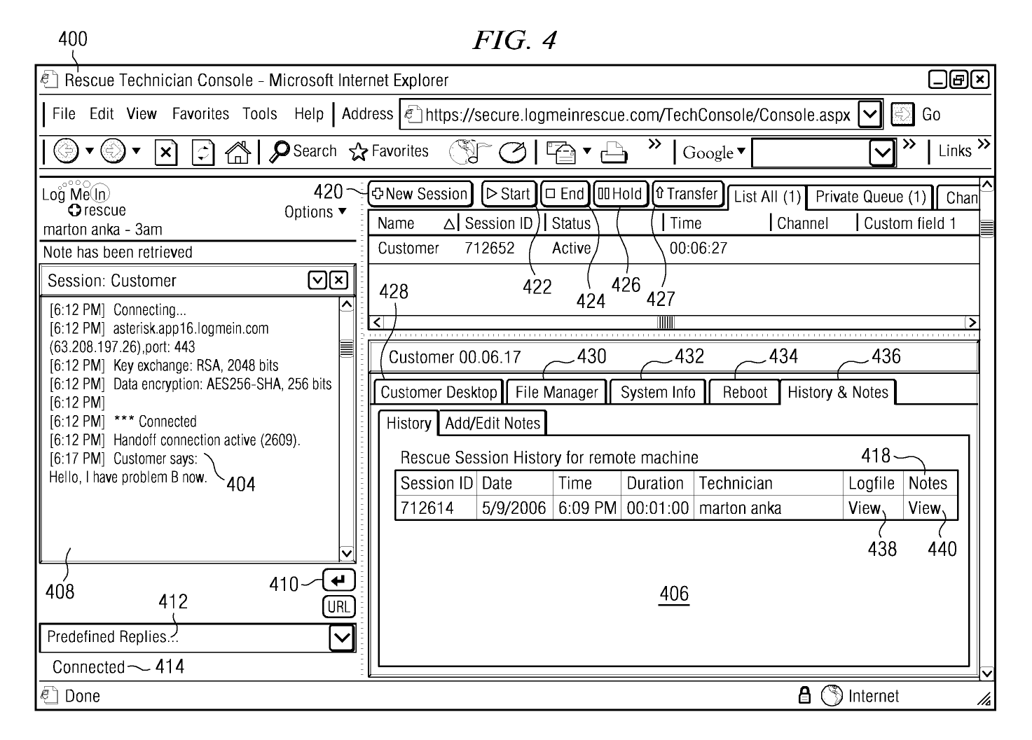

FIG. 4 illustrates a screen shot of a display viewed by a technician at the technician computer 102. The screen display is shown in a browser window 400. Although the browser shown is the Internet Explorer™ developed and marketed by Microsoft Corporation, those skilled in the art would understand that other conventional Internet browsers could also be used. The browser window 400 displays three areas. The first is a session list 402 that displays a list of the sessions currently in progress and information about each session, such as the customer name, session ID, session status and the elapsed time of a session and that allows the technician to select a session. Such sessions can be initiated and controlled via buttons 420-426.

The second area displays a scrolling list 404 that displays events and chat questions and responses. This list operates in the same manner as the scrolling list that is displayed to the user and shown in FIG. 3. A text box 408 is provided for the technician to enter chat questions or response; these can then be sent to the supported computer via the send button 410. Alternatively, a predefined reply can be selected from drop-down list 412 and sent to the supported computer. A status box 414 shows the status of the connection between the technician computer and the supported computer.

The last tabbed area 406 displays information concerning the supported computer. By selecting an appropriate one of tabs 428-436, information from the supported computer can be displayed, or the supported computer can be controlled. For example, by selecting tab 428, the desktop currently displayed on the supported computer can be displayed on the technician display. Selecting tab 430 displays controls associated with a file manager that allows the technician to download files, such as updates or patches, and transfer files from one location on the supported computer to another location. Selecting tab 432 displays the system information of the supported computer and selecting tab 434 displays controls that allow the supported computer to be rebooted and reconnected to the technician computer.

Selecting tab 436 displays session history that has been stored for any previous support sessions. Each session which has saved information is displayed in a list 418 and displayed information concerning that session includes the session ID, the date on which the session was conducted, the time at which the session began, the duration of the session and the technician involved. As described below, the inventive system also automatically stores a logfile of the events and chat responses displayed in scrolling list 404 and any notes entered by the technician during and immediately after, the support session. Selecting the “Logfile” area 438 of the session list for a displayed session displays the stored logfile information. Similarly, selecting the “Notes” area 440 of the session list for a displayed session displays any stored technician notes.

Because session history information, including the logfile information and technician notes, is typically very useful should further support be necessary, it is commonly stored in a database, such as database 134 (shown in FIG. 1), on a gateway server, such as server 138. In this manner, the support history for the supported computer is available for later retrieval by another technician. In accordance with the principles of the invention, the supported computer is automatically identified so that the corresponding support history can be retrieved during a support session and presented to the technician.

In particular, during a subsequent support session if the same supported computer is used to run the support applet to resolve another incident or to continue working on a previous incident, and there is an existing support history (logs and/or notes) for this particular computer, the computer is identified by the applet, the existing support history is retrieved from the gateway database and the support history is made immediately available to the technician in the support history window 406 of the technician computer 102.

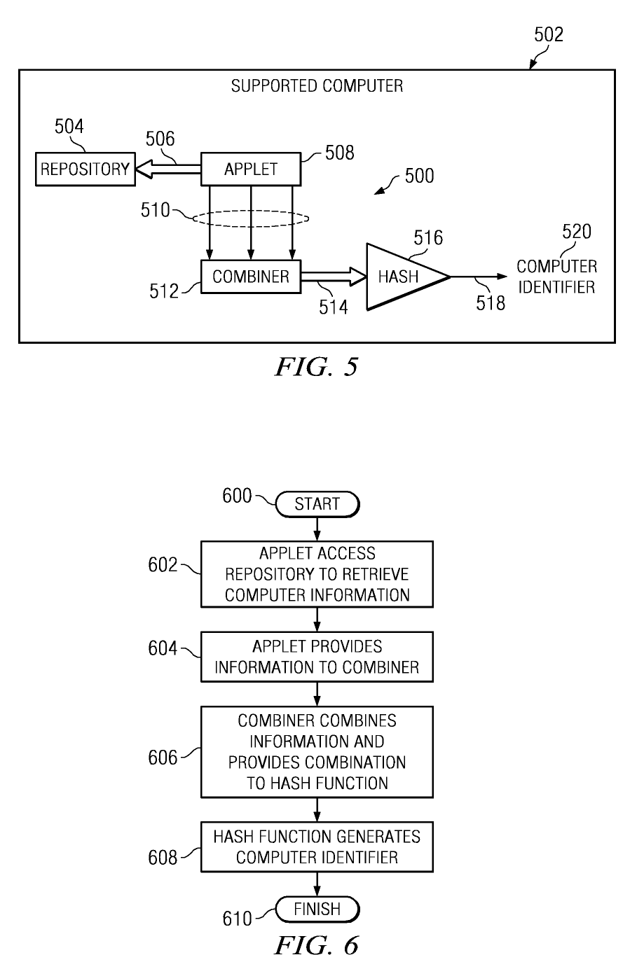

The mechanism 500 used to automatically identify a computer is illustrated in FIG. 5 and the steps involved in the computation are illustrated in FIG. 6. The supported computer 502 is identified by collecting several pieces of information about the hardware and the operating system. In particular, the process starts in step 600 and proceeds to step 602 where the applet 508 running in the supported computer accesses a repository 504 of system information to collect selected information as indicated schematically by arrow 506. For example, in computers that use operating systems developed and manufactured by Microsoft Corporation, this repository 504 might be a system registry, but other repositories could also be accessed. Examples of collected data include the MAC address of the primary network adapter, the CPU type and speed, the serial number of the system hard drive, the operating system product ID, etc.

Any one of the aforementioned pieces of information alone would probably not be enough to uniquely identify a computer, and the risk of a false positive would be high, when, for example, a hard drive is moved from one computer to another. To solve this problem and generate a unique identifier for the particular computer system, the applet 508 collects a plurality of information pieces in step 602 and provides them, in step 604, as indicated schematically by arrows 510, to a combiner 512. In step 606, the combiner 512 combines the information, for example, by concatenating the separate pieces and provides the combined information to a one-way cryptographic hash function 516 as indicated schematically by arrow 514. In step 608, the hash function generates the computer identifier. The hash function 516 Such a cryptographic hash function, might, for example, be an MD5 hash function as described in RFC1321 at the web site located at URL ietf.org/rfc/rfc1321.txt or an SHA-1 secure hashing algorithm as described in FIPS 180-1 at the web site located at URL itl.nist.gov/fipspubs/fip180-1.htm. Such a hashing function produces a fixed-length number that acts as a computer identifier 520 as indicated by arrow 418 that has a very high likelihood to be unique to that particular computer system. However, because of the one-way hash function, the computer identifier does not expose any potentially sensitive data from the supported computer that is used to make up the identifier. The process then finishes in step 610.

The computer identifier 520 is stored in the database 134 as a key for the support information, such as notes and logs that are stored during each support session. Support session notes and logs may, for example, be stored as records, or as image files, of the screen display that is presented during a support session. When a new support incident is handled using the inventive system, the applet 508 running on the supported computer will retrieve information from the supported computer, calculate a computer identifier using the arrangement shown in FIG. 5 and send it to the gateway location 146. The computer identifier is then applied to the server 138 and used to access database 134. If there is support history in the database 134 that corresponds with the applied computer identifier, it is retrieved and forwarded to the technician computer 102 and automatically made available to the technician who can use this information to locate and display logs and notes related to previous incidents.

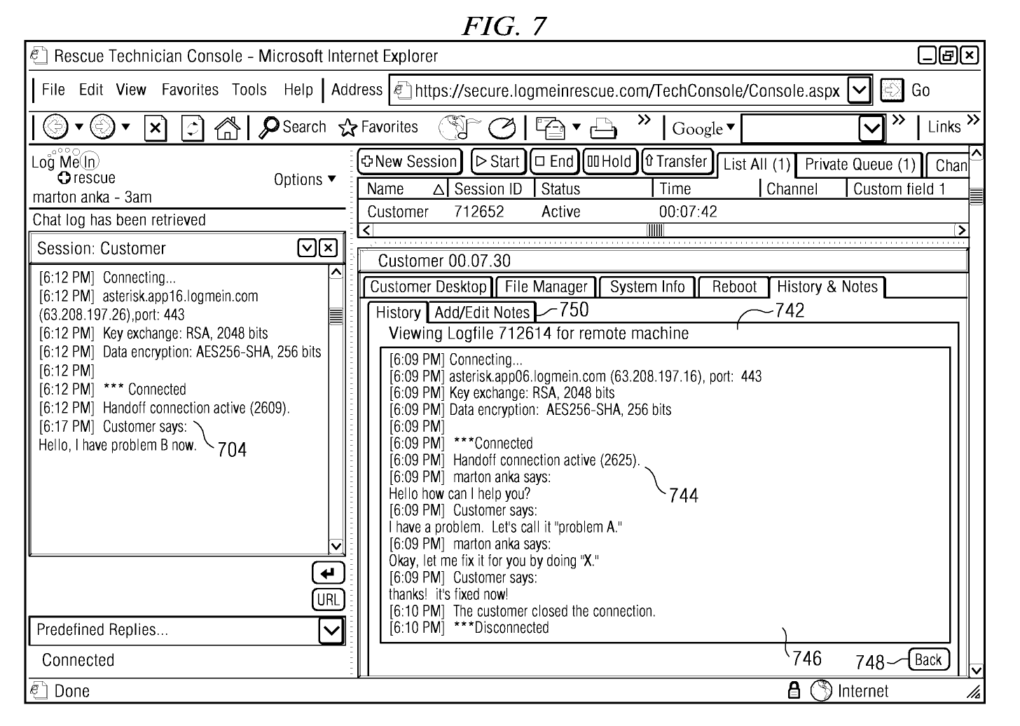

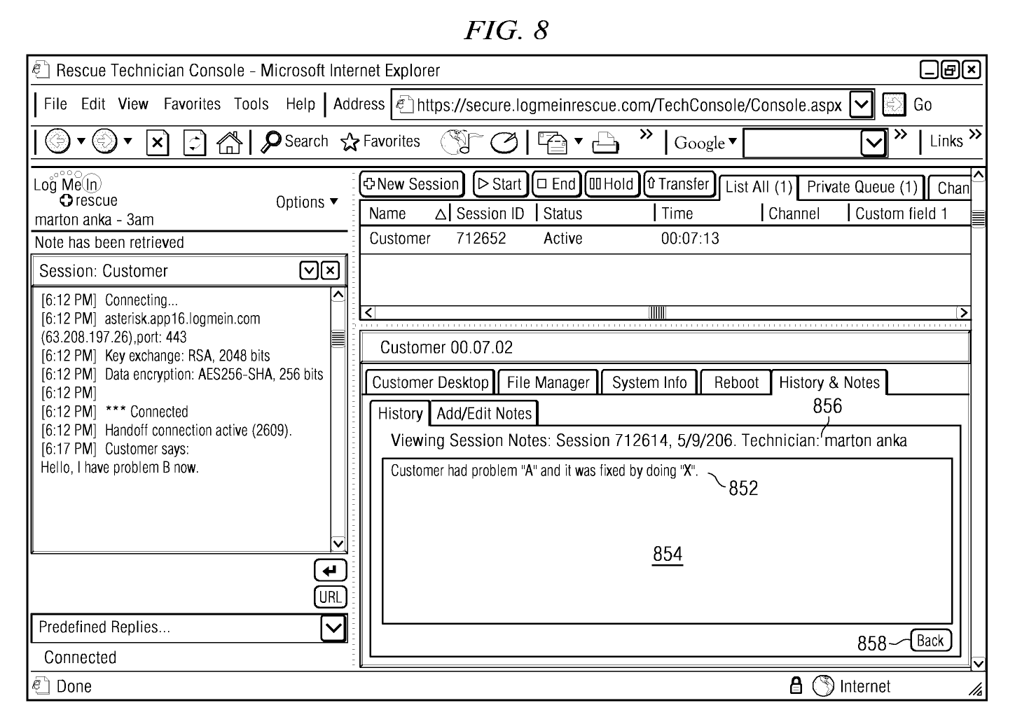

Such a technician screen display is shown in FIGS. 7 and 8. FIG. 7 illustrates the display of a logfile that was generated during a support session and stored on a gateway server. This display is initiated when the “logfile” section 438 (FIG. 4) of the session list for a particular session is selected as previously described. When the display is initiated, tabbed pages are displayed. The first tabbed page 742 with the tab labeled “History” displays a scrolling list 744 of stored events and chat responses that were originally displayed in scrolling list 704. This display may, for example, be a displayed image file, such as a “gif” or “bmp” file. The display can be scrolled by means of the scrollbar 746. Selection of the “Back” button 748 causes the display to revert to that shown in FIG. 4.

If the “Add/Edit Notes” tab 750 is selected, the display shown in FIG. 8 is presented to the technician. In this display, a scrolling list 852 of technician-entered notes is displayed. This list can be scrolled by means of scrollbar 854. In addition, a title line 856 is provided that indicates the session number for which the notes were entered, the date on which the notes were entered and the technician who entered the notes. The “Back” button 858 can be selected to return to the display shown in FIG. 4.

A software implementation of the above-described embodiment may comprise a series of computer instructions either fixed on a tangible medium, such as a computer readable media, for example, a diskette, a CD-ROM, a ROM memory, or a fixed disk, or transmittable to a computer system, via a modem or other interface device over a medium. The medium either can be a tangible medium, including but not limited to optical or analog communications lines, or may be implemented with wireless techniques, including but not limited to microwave, infrared or other transmission techniques. It may also be the Internet. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, e.g., shrink wrapped software, pre-loaded with a computer system, e.g., on system ROM or fixed disk, or distributed from a server or electronic bulletin board over a network, e.g., the Internet or World Wide Web.

Although an exemplary embodiment of the invention has been disclosed, it will be apparent to those skilled in the art that various changes and modifications can be made which will achieve some of the advantages of the invention without departing from the spirit and scope of the invention. For example, it will be obvious to those reasonably skilled in the art that, in other implementations, different functions may be used for the calculation of the computer identifier. Further different information than that disclosed can be retrieved from the supported computer and used to calculate the computer identifier. The order of the process steps may also be changed without affecting the operation of the invention. Other aspects, such as the specific process flow, as well as other modifications to the inventive concept are intended to be covered by the appended claims.

What is claimed is:

1. A method for conducting a support and diagnostic session on a supported computer from a remote technician computer via an intervening gateway server, the method comprising:
(a) downloading an applet from the gateway server to the supported computer;
(b) using the applet to collect a plurality of pieces of system information from the supported computer;
(c) combining the pieces of system information and passing the combined system information through a one-way cryptographic hash function to generate a computer ID; and
(d) using the computer ID to access the gateway server and to retrieve information saved during a previous support session.

2. The method of claim 1 wherein step (a) comprises downloading the applet from a website hosted by the gateway server.

3. The method of claim 1 wherein step (b) comprises using the applet to collect pieces of system information from the supported computer including a plurality of a MAC address of a primary network adapter, CPU type and speed, serial number of the system hard drive and operating system product ID.

4. The method of claim 1 wherein step (c) comprises concatenating the pieces of information.

5. The method of claim 1 wherein step (c) comprises passing the combined system information through one of an MD5 hash function and an SHA-1 hash function.

6. The method of claim 1 wherein step (d) comprises using the computer ID as a key to locate saved information on the gateway server and to retrieve that information.

7. The method of claim 1 further comprising:
(e) displaying the retrieved saved information at the technician computer.

8. The method of claim 1 wherein step (d) comprises retrieving saved information including events that occurred in the supported computer during a previous support and diagnostic session, chat questions and responses and any notes entered by a technician regarding the supported computer.

9. Apparatus for conducting a support and diagnostic session on a supported computer from a remote technician computer via an intervening gateway server, the apparatus comprising:
a mechanism that downloads an applet from the gateway server to the supported computer;
a mechanism in the applet that collects a plurality of pieces of system information from the supported computer;
a combiner that combines the pieces of system information;
a one-way cryptographic hash function that receives combined system information and generates a computer ID; and
a mechanism that uses the computer ID to access the gateway server and to retrieve information saved during a previous support session.

10. The apparatus of claim 9 wherein the mechanism that downloads the applet comprises a mechanism that downloads the applet from a website hosted by the gateway server.

11. The apparatus of claim 9 wherein the mechanism that collects pieces of system information from the supported computer collects information including a plurality of a MAC address of a primary network adapter, CPU type and speed, serial number of the system hard drive and operating system product ID.

12. The apparatus of claim 9 wherein the combiner comprises a mechanism that concatenates the pieces of information.

13. The apparatus of claim 9 wherein the one-way cryptographic hash function is one of an MD5 hash function and an SHA-1 hash function.

14. The apparatus of claim 9 wherein the mechanism that retrieves the stored information comprises a mechanism that uses the computer ID as a key to locate saved information on the gateway server and to retrieve that information.

15. The apparatus of claim 9 further comprising a mechanism that displays the retrieved saved information at the technician computer.

16. The apparatus of claim 9 wherein the saved information comprises events that occurred in the supported computer during a previous support and diagnostic session, chat questions and responses and any notes entered by a technician regarding the supported computer.

17. Apparatus for conducting a support and diagnostic session on a supported computer from a remote technician computer via an intervening gateway server, the apparatus comprising:
means for downloading an applet from the gateway server to the supported computer;
means in the applet for collecting a plurality of pieces of system information from the supported computer;
means for combining the pieces of system information and passing the combined system information through a one-way cryptographic hash function to generate a computer ID; and
means for using the computer ID to access the gateway server and to retrieve information saved during a previous support session.

18. The apparatus of claim 17 wherein the means for retrieving the stored information comprises means for using the computer ID as a key to locate saved information on the gateway server and for retrieving that information.

19. The apparatus of claim 17 further comprising means for displaying the retrieved saved information at the technician computer.

20. The apparatus of claim 19 wherein the saved information comprises events that occurred in the supported computer during a previous support and diagnostic session, chat questions and responses and any notes entered by a technician regarding the supported computer.
